(19) United States
(12) Patent Application Publication
(10) Pub. No.: US 2011/0290051 A1
(43) Pub. Date: Dec. 1, 2011

(54) Flywheel System With A Variable Speed Drive

(76) Inventors: Frederick E. Morgan, Coral Springs, FL (US); Christopher V. Barone, Coral Springs, FL (US)

(21) Appl. No.: 13/040,742

(22) Filed: Mar. 4, 2011

Related U.S. Application Data
(60) Provisional application No. 61/311,627, filed on Mar. 8, 2010.

(51) Int. Cl. F16H 35/06; F16C 15/00

(52) U.S. Cl. 74/396

(57) ABSTRACT

A variable speed drive for a flywheel system can have a first rotatable drive plate for coupling to a rotatable flywheel. The first drive plate can be positioned about an axis of rotation and have a drive surface lying generally laterally, across or transverse to the axis of rotation. A first rotatable drive wheel can have an outer circumference for engaging and being driven by the drive surface of the first drive plate. A generator can be rotatably coupled to the first drive wheel. A first actuator can control position of the first drive wheel relative to radial drive surface location on the first drive plate for controlling drive ratio and rotational speed of the generator.

This application claims the benefit of U.S. Provisional Application No. 61/311,627, filed on Mar. 8, 2010. The entire teachings of the above application are incorporated herein by reference.

### BACKGROUND

Flywheel Systems used for generating power can include a rotatable flywheel which drives a generator for generating electricity. Over time during use, the rotational speed of the flywheel decreases. In some situations, this can be in an issue, for example if the generator is an AC generator.

### SUMMARY

The present invention can provide a flywheel system with a variable speed drive, which can if desired, drive a generator at a constant rotational speed.

In one embodiment, the variable speed drive can have a first rotatable drive plate for coupling to a rotatable flywheel. The first drive plate can be positioned about an axis of rotation and have a drive surface lying generally laterally, across or transverse to the axis of rotation. A first rotatable drive wheel can have an outer circumference for engaging and being driven by the drive surface of the first drive plate. A generator can be rotatably coupled to the first drive wheel. A first actuator can control position of the first drive wheel relative to radial drive surface location on the first drive plate for controlling drive ratio and rotational speed of the generator.

In particular embodiments, a control system can control the position of the first drive wheel to provide a constant rotational speed of the generator with changing rotational speed of the first drive plate. The first drive wheel can be rotatably locked to a first drive wheel shaft while also being linearly slidable thereon. The first actuator can control linear position of the first drive wheel on the first drive wheel shaft. A rotatable power source, such as a motor, can be included. A second rotatable drive wheel can be coupled to the rotatable power source. A second rotatable drive plate can be coupled to the rotatable flywheel. The second drive plate can be positioned about the axis of rotation and have a drive surface lying generally laterally, across or transverse to the axis of rotation. The second drive wheel can have an outer circumference for engaging the drive surface of the second drive plate for rotatably driving the second drive plate, and therefore the rotatable flywheel. A second actuator can control radial position of the second drive wheel relative to radial drive surface location on the second drive plate for controlling drive ratio and rotational speed at which the second drive plate is driven, and therefore the flywheel. The control system can control the position of the second drive wheel to drive the second drive plate at a desired rotational speed. The second drive wheel can be rotatably locked to a second drive wheel shaft while also being linearly slidable thereon. The second actuator can control linear position of the second drive wheel on the second drive wheel shaft.

The present invention can also provide a flywheel system including a rotatable flywheel mounted on a horizontal flywheel shaft and rotatable about an axis of rotation. A generator drive assembly can be driven by the flywheel. The generator drive assembly can include a first rotatable drive plate mounted to the flywheel shaft for rotation about the axis of rotation and can have a drive surface lying generally laterally, across or transverse to the axis of rotation. A first rotatable drive wheel can have an outer circumference for engaging and being driven by the drive surface of the first drive plate. A generator can be rotatably coupled to the first drive wheel. A first actuator can control position of the first drive wheel relative to radial drive location on the first drive plate for controlling drive ratio and rotational speed of the generator.

In particular embodiments, a control system can control the position of the first drive wheel to provide a constant rotational speed of the generator with changing rotational speed of the first drive plate. The first drive wheel can be rotatably locked to a first drive wheel shaft while also being linearly slidable thereon. The first actuator can control linear position of the first drive wheel on the first drive wheel shaft. The flywheel system can include a drive assembly for driving the flywheel to a desired speed. The drive assembly can include a rotatable power source, such as a motor. A second rotatable drive wheel can be coupled to the rotatable power source. A second rotatable drive plate can be mounted to the flywheel shaft for rotation about the axis of rotation and can have a drive surface lying generally laterally, across or transverse to the axis of rotation. The second drive wheel can have an outer circumference for engaging the drive surface of the second drive plate for rotatably driving the second drive plate and the flywheel. A second actuator can control radial position of the second drive wheel relative to radial drive surface location on the second drive plate for controlling drive ratio and rotational speed at which the second drive plate and flywheel are driven. The control system can control the position of the second drive wheel to drive the second drive plate and the flywheel at a desired rotational speed. The second drive wheel can be rotatably locked to a second drive wheel shaft while also being linearly slidable thereon. The second actuator can control linear position of the second drive wheel on the second drive wheel shaft. The first and second drive plates can be located on opposite sides of the flywheel and can be spaced apart from the flywheel. The drive surfaces of the first and second drive plates can face outwardly relative to the flywheel such that the first and second drive wheels can exert force on the first and second drive plates in generally opposite axial directions relative to the flywheel shaft. An enclosure can surround the flywheel. The first and second drive plates can be located outside the enclosure.

The present invention can also provide a method of driving a generator with a variable speed drive for a flywheel system including coupling a first rotatable drive plate to a rotatable flywheel positioned about an axis of rotation and having a drive surface lying generally across the axis of rotation. The outer circumference of a first rotatable drive wheel can engage with the drive surface of the first drive plate for driving the first drive wheel. A generator can be rotatably coupled to the first drive wheel. A first actuator control can position of the first drive wheel relative to radial drive surface location on the drive plate for controlling drive ratio and rotational speed of the generator.

In particular embodiments, the position of the first drive wheel can be controlled with a control system to provide a constant rotational speed of the generator with changing rotational speed of the first drive plate. The first drive wheel can be rotatably locked to a first drive wheel shaft while also being linearly slidable thereon. The first actuator can control linear position of the first drive wheel on the first drive wheel shaft. A rotatable power source such as a motor can be provided. A second rotatable drive wheel can be coupled to the rotatable power source. A second rotatable drive plate can be coupled to the rotatable flywheel, and can be positioned about the axis of rotation and have a drive surface lying generally across the axis of rotation. The second drive wheel can have an outer circumference for engaging the drive surface of the second plate for rotatably driving the second drive plate, and therefore the rotatable flywheel. A second actuator can control radial position of the second drive wheel relative to radial drive location on the second drive plate for controlling drive ratio and rotational speed at which the second drive plate and the flywheel are driven. The position of the second drive wheel can be controlled with the control system to drive the second drive plate at the desired rotational speed. The second drive wheel can be rotatably locked to a second drive wheel shaft while also being linearly slidable thereon. A second actuator can control linear position of the second drive wheel on the second drive wheel shaft.

The present invention can also provide a method of driving a generator with a flywheel system including mounting a rotatable flywheel on a horizontal flywheel shaft and rotating the flywheel about an axis of rotation. A generator drive assembly can be driven with the flywheel by mounting a first rotatable drive plate to the flywheel shaft for rotation about the axis of rotation and having a drive surface lying generally across the axis of rotation. An outer circumference of a first rotatable drive wheel can engage with the drive surface of the first drive plate for driving the first drive wheel. The generator can be rotatably coupled to the first drive wheel. A first actuator can control position of the first drive wheel relative to radial drive surface location on the first drive plate for controlling drive ratio and rotational speed of the generator.

In particular embodiments, the position of the first drive wheel can be controlled with a control system to provide a constant rotational speed of the generator with changing rotational speed of the first drive plate and flywheel. The first drive wheel can be rotatably locked to a first drive wheel shaft while also being linearly slidable thereon. The first actuator can control linear position of the first drive wheel on the first drive wheel shaft. The flywheel can be driven to a desired speed with a drive assembly. A rotatable power source such as a motor can be provided. A second rotatable drive wheel can be coupled to the rotatable power source. A second rotatable drive plate can be mounted to the flywheel shaft for rotation about the axis of rotation and can have a drive surface lying generally across the axis of rotation. The second drive wheel can have an outer circumference for engaging the drive surface of the second drive plate for rotatably driving the second drive plate and the flywheel. A second actuator can control the radial position of the second drive wheel relative to radial drive surface location on the second drive plate for controlling drive ratio and rotational speed at which the second drive plate and flywheel are driven. The position of the second drive wheel can be controlled with the control system to drive the second drive plate and flywheel at a desired rotational speed. The second drive wheel can be rotatably locked to a second drive wheel shaft while also being linearly slidable thereon. The second actuator can control the linear position of the second drive wheel on the second drive wheel shaft. The first and second drive plates can be located on opposite sides of the flywheel and spaced apart from the flywheel. The drive surfaces of the first and second drive plates can face outwardly relative to the flywheel such that the first and second drive wheels exert force on the first and second drive plates in generally opposite axial directions. An enclosure can surround the flywheel, and the first and second drive plates can be located outside the enclosure.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a perspective view of an embodiment of a flywheel system in the present invention.

FIGS. 2 and 3 are perspective views of an embodiment of a motor drive assembly.

FIG. 4 is a perspective view of the flywheel system of FIG. 1 from the opposite side.

FIGS. 5 and 6 are perspective views of an embodiment of a generator drive assembly.

FIG. 6A is a schematic drawing of one embodiment of a control system.

FIG. 7 is a perspective view of another embodiment of a flywheel system in the present invention.

FIG. 8 is a top view of the flywheel system of FIG. 7.

FIG. 9 is a sectional view of the flywheel system of FIG. 8.

FIG. 10 is a perspective view of another embodiment of a motor drive assembly.

FIG. 11 is an end view of the motor drive assembly of FIG. 10.

FIG. 12 is a sectional view of the motor drive assembly of FIG. 11.

FIG. 13 is a perspective view of another embodiment of a generator drive assembly.

FIG. 14 is an end view of the generator drive assembly of FIG. 13.

FIG. 15 is a sectional view of the generator drive assembly of FIG. 14.

FIG. 16 is a perspective view of another embodiment of a drive wheel.

FIG. 17 is a front view of the drive wheel of FIG. 16.

FIG. 18 is a rear perspective view of an embodiment of a drive plate.

FIG. 19 is a rear view of the drive plate of FIG. 18.

FIG. 20 is a sectional view of another embodiment of a drive wheel.

FIG. 21 is an enlarged portion of the drive wheel of FIG. 20.

FIG. 22 is a sectional view of another embodiment of a drive wheel.

FIG. 23 is an enlarged sectional view of a portion of another embodiment of a drive wheel.

FIG. 24 is a sectional view of still another embodiment of a drive wheel.

FIG. 25 is a top view of a portion of another embodiment of a drive assembly.

### DETAILED DESCRIPTION

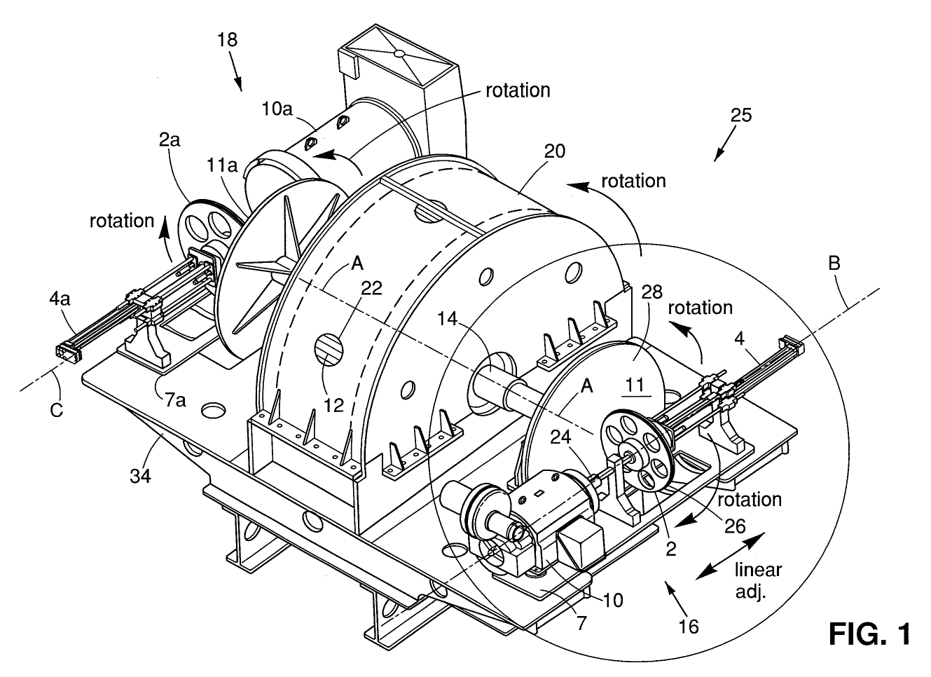

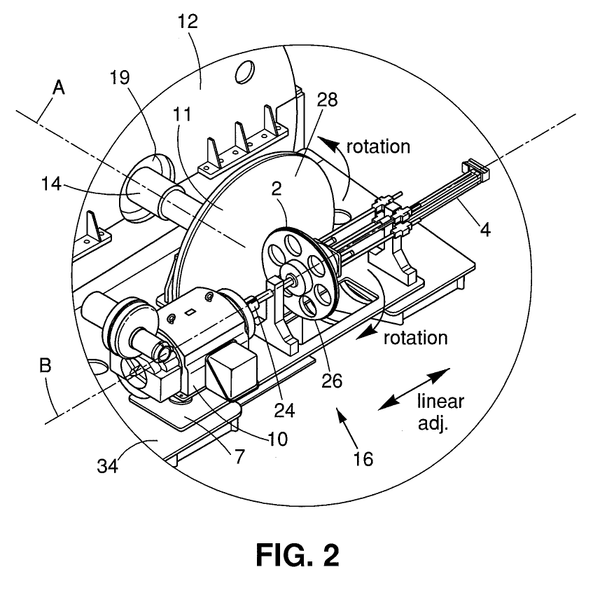

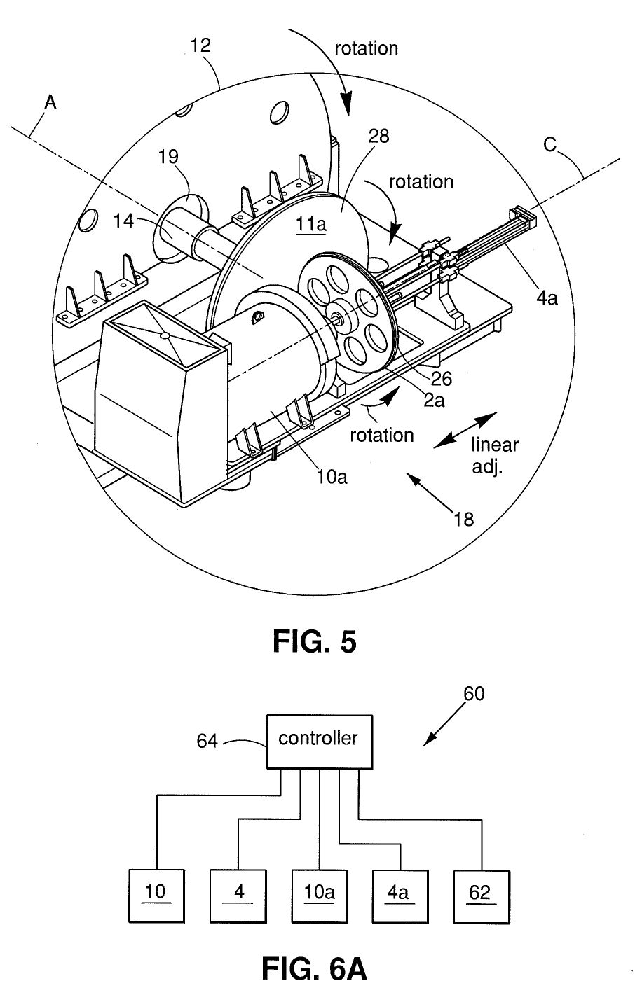

Referring to FIGS. 1-6, the present invention in one embodiment, can provide a flywheel system 25 having a flywheel 12 (portions shown inside a flywheel enclosure or housing 20 seen through window 22) rotatably coupled to a motor drive assembly 16, and a generator drive assembly 18 on a support or mounting frame or stand 34. The environment within the enclosure 20 can be under vacuum or have a low density gas. The motor drive assembly 16 can bring the flywheel 12 up to a desired rotational speed about axis A, and can be adjusted to adjust the speed that it drives the flywheel 12. The generator drive assembly 18 can be adjusted to drive a generator 10a at a desired or constant speed, such as 1800 RPM, regardless of the speed that the flywheel 12 is rotating. The flywheel 12 can be rotated above 1000 RPM by the motor drive assembly 16, for example in some embodiments, in the range of 3000 RPM to 6000 RPM, and in some instances, up to about 10,000 RPM.

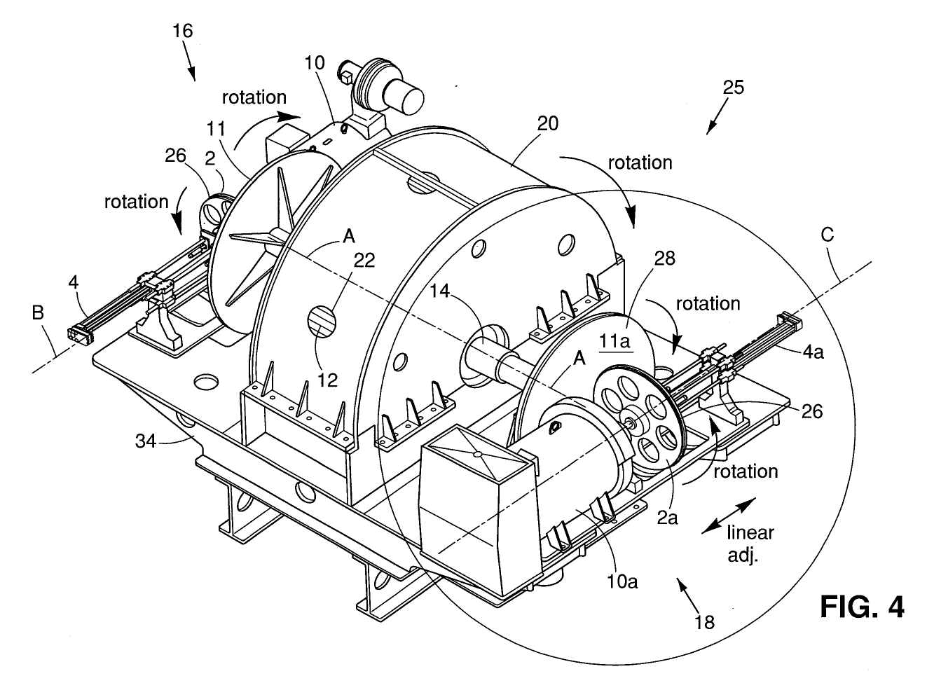

Referring to FIGS. 1-3, the motor drive assembly 16 can include a motor 10. The motor 10 can be an AC or DC motor, and can be rotated up to a desired speed, for example, 3600 RPM. In other embodiments, the rotational speed can vary. A motor drive round rotatable member or wheel 2, can be rotatably coupled to the motor 10 by a rotatable drive shaft 24, and a drive wheel shaft which can be a ball spline shaft 3 about axis B. The rim or outer periphery or circumference 26 of the drive wheel 2 can have a drive surface which engages a drive surface 28 of a round rotatable motor drive member or plate 11 in rolling contact. The outer circumference 26 can have a narrow annular ridge or crown 76 that contacts the drive surface 28. The drive surface 28 can be a flat or planar face of the drive plate 11 which can be generally extended, positioned or lying laterally, across or transverse, and normal or perpendicular, to the axis of rotation A of the flywheel 12 and the drive plate 11. The drive plate 11 can be coupled to the flywheel 12 on the flywheel shaft 14 for rotation about a common axis of rotation A. Axis A can be positioned across, transverse, 90° or perpendicular to the shaft 24 of the motor 10, shaft 3 and axis B. Rolling engagement of the rim of the drive wheel 2 on the flat face of the drive plate 11 rotates the drive plate 11 and shaft 14 about the axis of rotation A of shaft 14, thereby also rotating the flywheel 12. This configuration can form a traverse, 90°, perpendicular, or right angle transmission. The flywheel 12 can be positioned upright with shaft 14 lying along a horizontal axis A and supported by bearings 30, such as hydrodynamic bearings or other suitable bearings such as magnetic or ball bearings, on bearing pedestals or mounts 32 (FIG. 4) that are secured to frame 34. The shaft 24 of the motor 10 can be coupled to ball spline shaft 3, both of which can be positioned horizontally on axis B. The horizontal or linear position of the drive wheel 2, (for example, the distance between drive wheel 2 and the motor 10) can be adjusted by a linear actuator 4 which can translate, move or slide the drive wheel 2 linearly or longitudinally along the drive wheel shaft or ball spline shaft 3 along axis B, and laterally or radially relative to drive plate 11, as shown by the arrows. The drive wheel 2 can be rotatably locked to the drive wheel shaft or ball spline shaft 3 while being linearly slidable thereon.

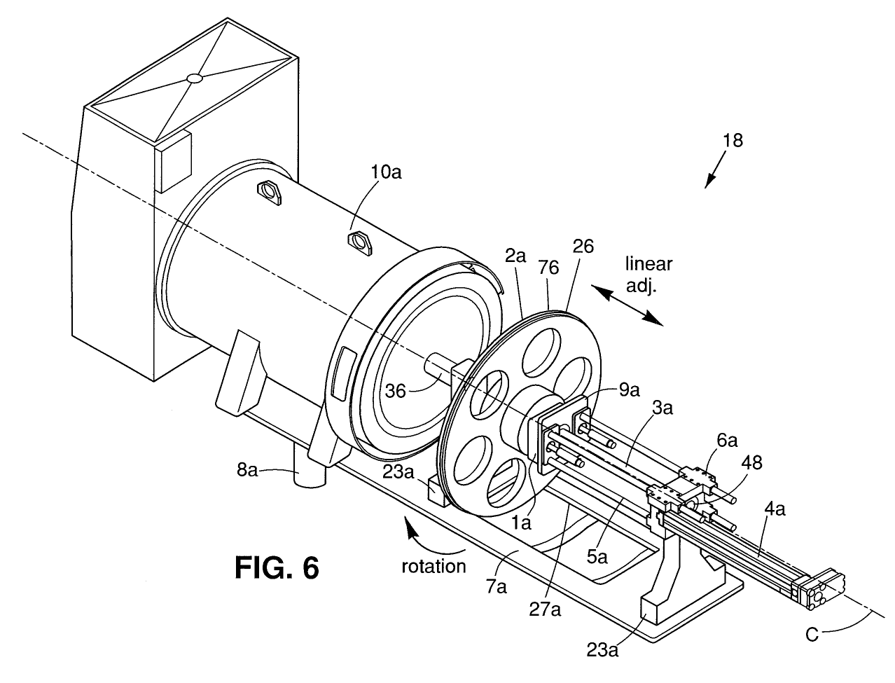

Moving the linear position of the drive wheel 2 changes the radial contact position of the drive wheel 2 on the drive plate 11 relative to the drive surface 28 or center of the drive plate 11 and axis A, thereby changing the drive ratio and the rotational speed at which the drive wheel 2 drives the drive plate 11 and therefore the flywheel 12. As a result, to drive the drive plate 11 and flywheel 12 slower, the drive wheel 2 can be radially adjusted to contact the drive plate 11 near the outer rim of the drive plate 11 and away from the center and axis A. In order to drive the drive plate 11 and the flywheel 12 faster, the drive wheel 2 can be radially adjusted to contact the drive plate 11 closer to the center of the drive plate 11 and axis A. The motor 10 and the linear actuator 4 can be connected to a control system 60 (FIG. 6A) that can have a controller 64, sensors 62 and electronics which can be used to adjust the radial position of the drive wheel 2 relative to the drive plate 11 to obtain the desired speed of flywheel 12. The sensors 62 can include various position sensors and rotational speed sensors associated with some or all of the flywheel 12, shaft 14, drive plate 11, drive wheel 2, linear actuator 4, and motor 10. The motor drive assembly 16 can be mounted to a movable or positionable frame, such as a pivot frame 7 having a pivot hub 8, which allows an actuator such as a hydraulic or pneumatic cylinder to move or pivot the pivot frame 7 to position the drive wheel 2 in horizontal or lateral pressure engagement or traction with the drive plate 11, or for disengagement.

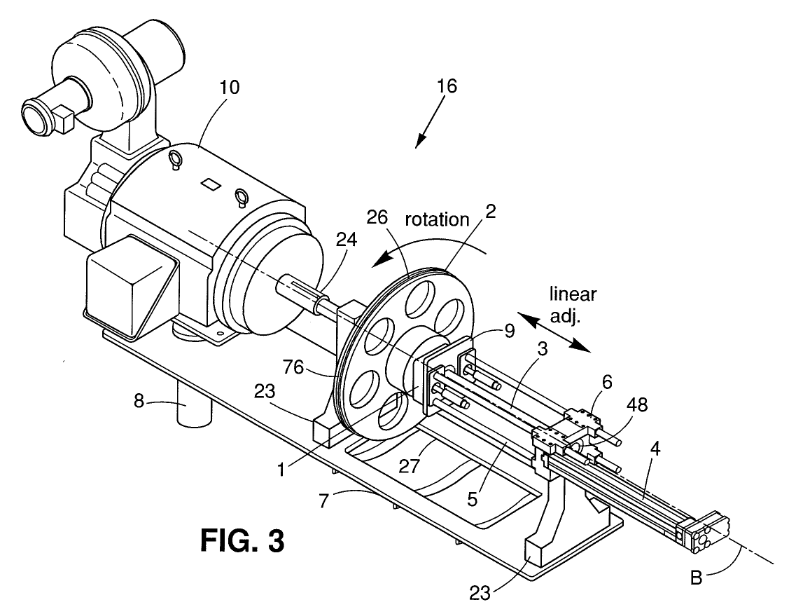

Referring to FIG. 3, the linear actuator 4 can have a linear bearing housing or assembly 6 for slidably guiding the guide shafts 5 which guide the linear movement of the drive wheel 2 when linearly actuated or moved by the linear actuator 4. In some embodiments the linear actuator can have a reciprocating actuator rod, or other suitable movable actuation member for moving bearing housing retainer 9 or guide shafts 5, or can be one of the guide shafts 5. The bearing housing retainer 9 can be secured to a bearing housing coupler 1, and act as a mounting surface for the guide shafts 5. The bearing housing coupler 1 houses bearings which allows the drive wheel 2 to rotate with the drive wheel shaft or ball spline shaft 3, including while being translated horizontally or linearly along ball spline shaft 3 by the linear actuator 4, which does not rotate. The ball spline shaft 3 can be rotatably supported by two brackets 23 having bearings 48 that are mounted to pivot frame 7 and spaced apart from each other on opposite sides of the drive wheel 2. The linear actuator 4 and the linear bearing housing 6 can be mounted to the distal bracket 23, and can be slightly offset from axis B as shown. The pivot frame 7 can have an opening 27 for providing clearance for the drive wheel 2.

Referring to FIGS. 4-6, the generator drive assembly 18 can be positioned on the opposite axial side of the flywheel 12 from the motor drive assembly 16 and can have a similar construction to that of the motor drive assembly 16. The generator drive assembly 18 can include a rotating round generator drive member or plate 11a that is mounted to shaft 14, and is therefore driven by the rotation of flywheel 12 about the axis of shaft 14 and about a common axis of rotation A. A generator drive round rotatable member or wheel 2a can be rotatably mounted to a generator 10a by a drive shaft 36 about axis C, and a drive wheel shaft which can be a ball spline shaft 3a, and can be translated, moved or slid linearly or longitudinally along the ball spline shaft 3a and axis C, and laterally or radially relative to drive plate 11a, as shown by the arrows. The drive wheel 2a can be rotatably locked to ball spline shaft 3a while being linearly slidable thereon. Axis C can be horizontally oriented and across, transverse, at a right angle or perpendicular to axis A, and can be parallel to axis B. The outer rim, periphery or circumference 26 of drive wheel 2a can have a drive surface which engages the drive surface 28 of the drive plate 11a in rolling contact. The outer circumference 26 can have a narrow annular ridge or crown 76 that contacts the drive surface. The drive surface 28 can be a flat or planar surface of the drive plate 11a which can be generally extended, positioned or lying laterally, across or transverse, and normal or perpendicular, to the axis of rotation A of the flywheel 12 and the drive plate 11a. As a result, generator drive assembly 18 can also have a transverse or right angle transmission, and rotation of the flywheel 12 and the drive plate 11a about axis A can drive or roll the drive wheel 2a to rotate the drive wheel 2a about axis C and turn the generator 10a to generate electricity.

The horizontal or linear position of the drive wheel 2a relative to the generator 10a, drive surface 28, axis A, or the center of the drive plate 11a can be automatically adjusted by a linear actuator 4a to engage different radial locations on the drive surface 28 face of the drive plate 11a for controlling drive ratio and rotational speed of the generator 10a so that the generator 10a can be continuously rotated at a constant desired speed, such as 1800 RPM, regardless of the speed that flywheel 12 rotates. For example, as the rotational speed of flywheel 12 changes and decreases over time, the linear actuator 4a can automatically radially move the drive wheel 2a closer to the center of the drive plate 11a and axis A to maintain the same desired speed of generator 10a, for example, 1800 RPM. If the speed of the flywheel 12 changes and increases, the drive wheel 2a can move to outward radial locations on the drive plate 11a away from axis A. Rotating the generator 10a at a constant speed can be desirable, for example when the generator is an AC generator. In some embodiments, 1800 RPM can be suitable for 60 Hz output frequency, and 1500 RPM can be suitable for 50 Hz. In other embodiments, the generator can be a DC generator. The linear actuator 4a and the generator 10a can be connected to the control system 60 which can have sensors 62 and electronics for enabling automatic adjustment to maintain the desired speed. The sensors 62 can include various position sensors and rotational speed sensors associated with some or all of the flywheel 12, shaft 14, drive plate 11a, drive wheel 2a, linear actuator 4a and generator 10a. The linear actuator 4a can be similar to linear actuator 4. The drive wheel 2a can be also moved or positioned, for example, pivoted into horizontal or lateral pressure engagement or traction with drive plate 11a, or for disengagement, by a movable or positionable pivot frame 7a and pivot hub 8a, with an actuator, such as a hydraulic or pneumatic cylinder.

Referring to FIG. 6, the linear actuator 4a can have a linear bearing housing or assembly 6a for slidably guiding the guide shafts 5a which guide the linear movement of the drive wheel 2a when linearly actuated or moved by the linear actuator 4a. A bearing housing retainer 9a can be secured to a bearing housing coupler 1a, and act as a mounting surface for the guide shafts 5a. The bearing housing coupler 1a includes bearings which allows the drive wheel 2a to rotate with the drive wheel shaft or ball spline shaft 3a, including while being translated horizontally or linearly along ball spline shaft 3a by the linear actuator 4a, which does not rotate. The ball spline shaft 3a can be rotatably supported by two brackets 23a having bearings 48 that are mounted to pivot frame 7a and spaced apart from each other on opposite sides of the drive wheel 2a. The linear actuator 4a and the linear bearing housing 6 can be mounted to the distal bracket 23a, and can be slightly offset from axis C as shown. The pivot frame 7a can have an opening 27a for providing clearance for the drive wheel 2a.

The motor drive assembly 16 can bring the flywheel 12 up to a desired speed and then disengage, allowing the flywheel 12 to rotate freely. The generator drive assembly 18 can be engaged at the desired time to be driven by the flywheel 12 and generate electrical power. The motor drive assembly 16 can be reengaged periodically with the flywheel 12 to bring the flywheel 12 back up to a desired rotational speed, which can be before, during or after power generation. There can be times when both the motor drive assembly 16 and the generator drive assembly 18 are engaged at the same time. The motor drive assembly 16, motor 10, generator drive assembly 18 and/or generator 10a, can include clutches in some embodiments. This can allow the drive wheels 2 and/or 2a to remain engaged with drive plates 11 and 11a. The direction of rotation of the motor 10, generator 10a, flywheel 12, drive plates 11, 11a, and drive wheels 2, 2a, can be chosen as desired. The side of the axis A at which the drive wheels 2 and 2a contact drive plates 11 and 11a, can be chosen to determine the directions of rotation.

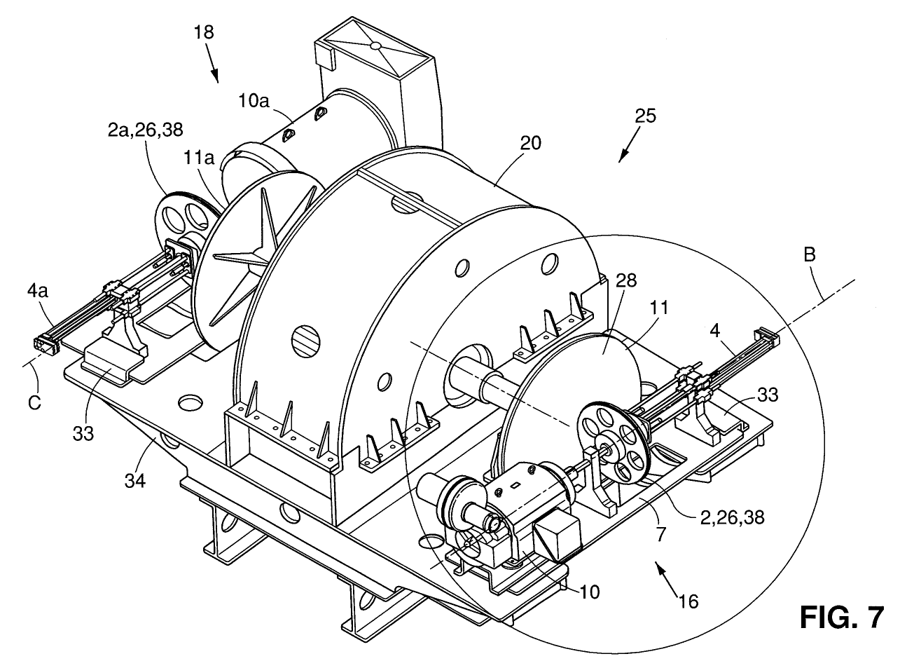

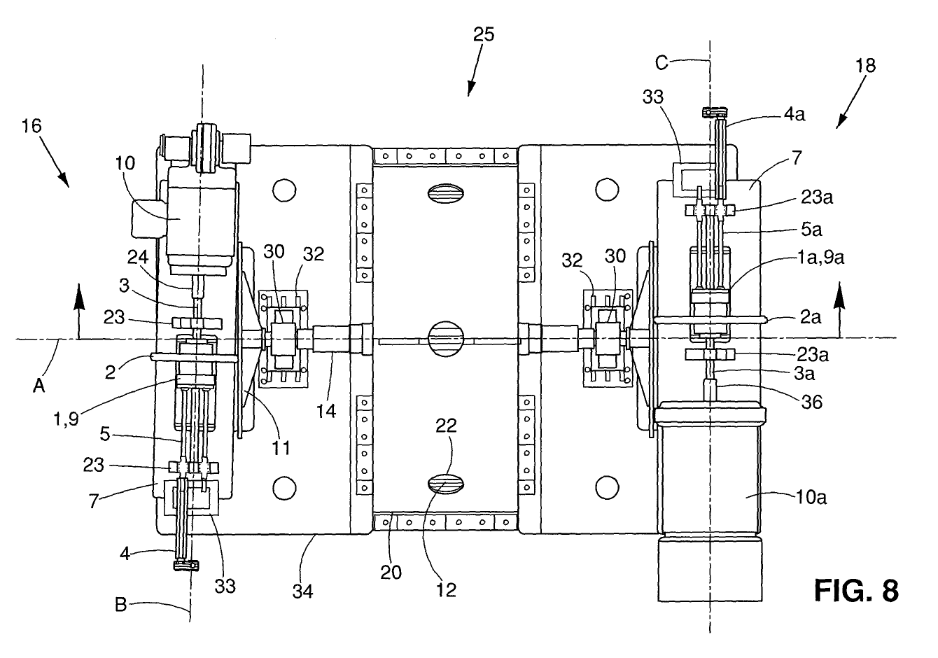

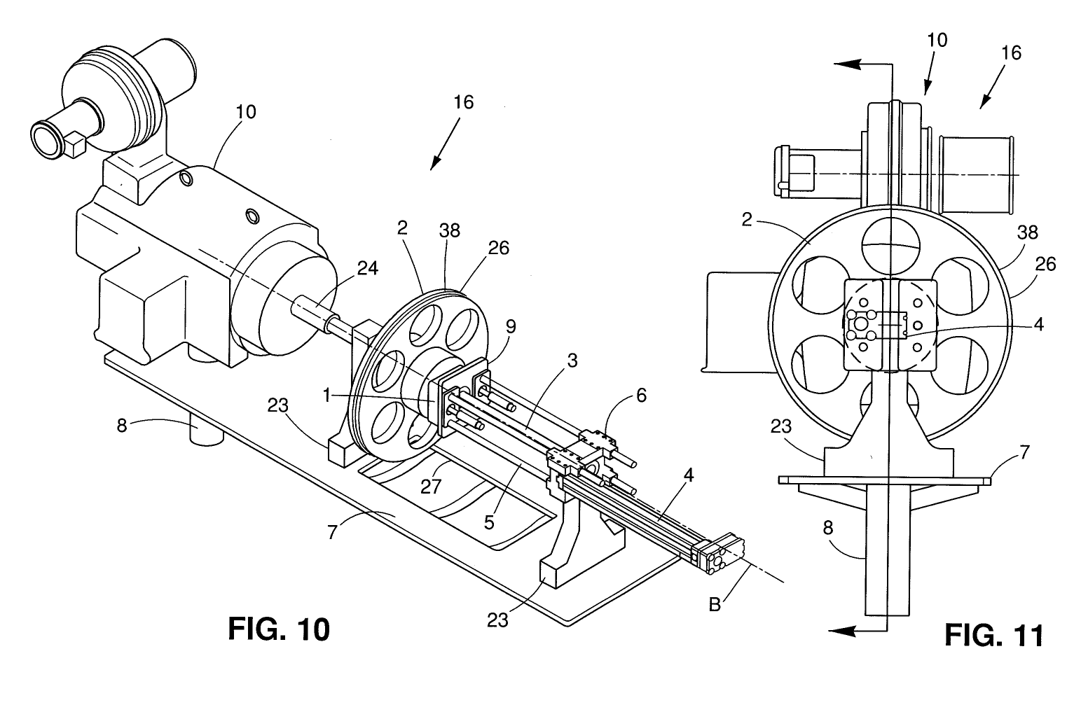

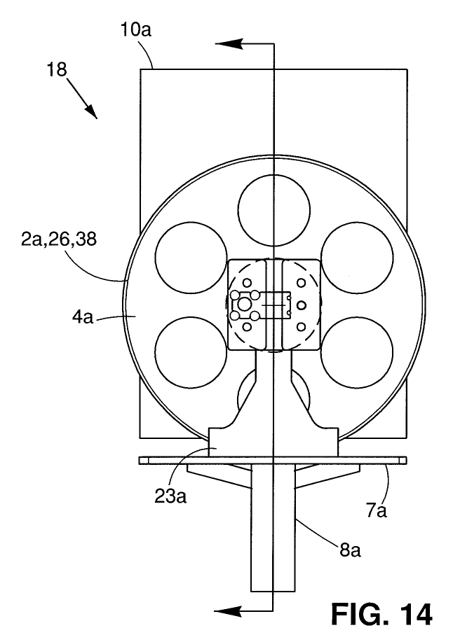

Referring to FIGS. 7-19, in another embodiment, the motor 10 of the motor drive assembly 16 can be a 500 HP motor for driving a flywheel 12 that is about 120 inches in diameter, 48 inches wide, and about 85,000 lbs. It is understood that the size and weight of the flywheel 12 can vary. The flywheel 12 can be mounted or constructed on the flywheel shaft 14 and can be formed of composite materials, which can include for example, metallic wires bonded together with resins and adhesives. Some embodiments of flywheel 12 can have a construction similar to that described in publication number US 2010/0083790, published Apr. 8, 2010, the contents of which are incorporated herein in its entirety by reference. In other embodiments, the flywheel 12 can be formed of metal or other suitable materials or methods. The diameter of the flywheel shaft 14 can be reduced at the ends, such as in two steps, as shown, or can alternatively have a constant diameter. In other embodiments, the size of the motor 10 and the flywheel 12 as well as the configuration and/or construction can vary. Retaining guide brackets 33 can be mounted to the upper surface of the frame 34 for movably capturing or trapping the upper surface of one or both ends of the pivot frames 7 and 7a, for guiding and allowing the pivot frames 7 and 7a to move, slide, translate or pivot laterally or horizontally, but not upwardly.

Embodiments of the drive wheel 2 that is driven by the motor 10 (FIGS. 16 and 17) can be formed of metal, such as aluminum, steel or cast iron, or composites. In one embodiment, the drive wheel 2 can have an outer base diameter of about 32 inches and can have an outer layer of material 38 on the outer circumference 26 for wear and contact purposes with the drive plate 11, which can be about ½ inch thick, resulting in a total outer diameter of about 33 inches. The outer layer of material 38 can be formed of a suitable material including polymeric material, rubber, urethane, metals such as steel, hardened steel or carbide, ceramics, can include frictional or hardened coatings, etc. The drive wheel 2 can have a central hub 40 for securement to a spline nut 50 with screws or bolts in mounting holes 43 for mounting to ball spline shaft 3, and can have a series of holes 42 for weight reduction. The same or a similar drive wheel can be used as the drive wheel 2a for the generator drive assembly 18, and can be the same size or can be of different sizes as needed or desired. The spline nut 50 and ball spline shaft 3 used can be of a type normally commercially available, and can allow linear or longitudinal motion of drive wheel 2 along ball spline shaft 3 while providing rotational torque transmission. Bearings 52 housed by the bearing housing coupler 1 can be fitted over neck 41 to provide a rotational joint between the non-rotating guide rods 5 of the linear actuator 4 and the rotatable drive wheel 2. Also, in the generator drive assembly 18, bearings 52 are housed by bearing housing coupler 1a and can be fitted over neck 41 for drive wheel 2a. As previously mentioned, in embodiments of the motor drive assembly 16 and the generator drive assembly 18, the guide shafts 5 or 5a moved by the linear actuators 4 or 4a, can be secured to bearing housing retainers 9 or 9a. The bearing housing retainers 9 or 9a can include a plate that is secured to non-rotating bearing housing couplers 1 or 1a. The bearings 52 can be fitted between the rotating neck 41 and the non-rotating bearing housing couplers 1 or 1a, to allow the drive wheels 2 or 2a to rotate while being connected to and linearly moved by the non-rotating linear actuators 4 or 4a.

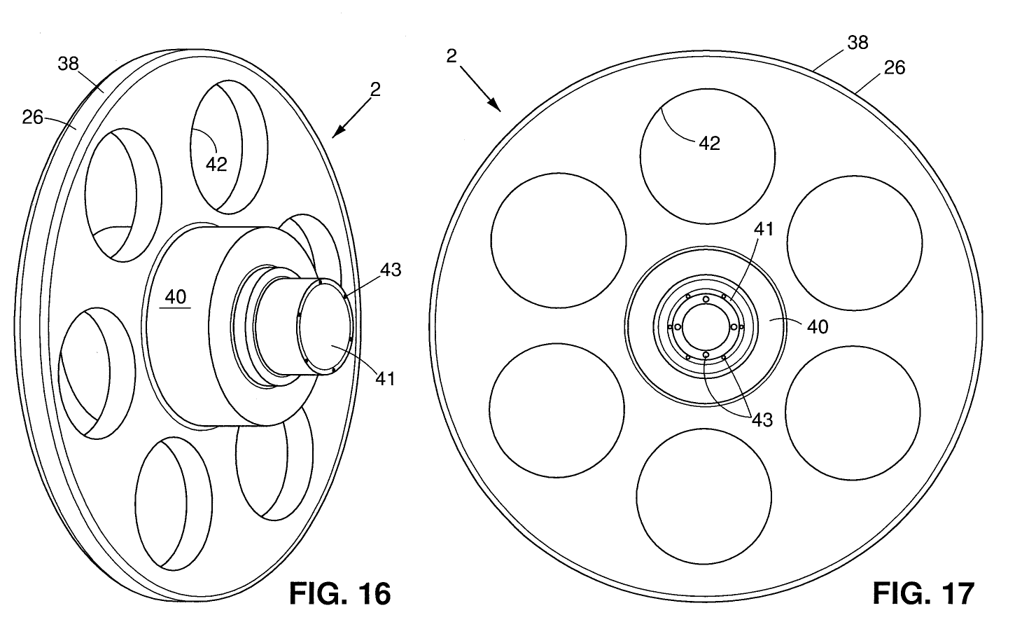

Embodiments of the drive plate 11 (FIGS. 18 and 19) of the motor drive assembly 16 can be formed of metal, such as aluminum, steel or cast iron, or composites, and can have a circular flat or planar drive surface 28 that can be textured or coated with frictional, hardened or wear resistant coatings. The drive plate 11 can have ribs 44 on the opposite side from the drive surface 28, which can extend radially for maintaining a flat drive surface face, as well as for strength and rigidity. The ribs 44 can also provide cooling during rotation. The drive plate 11 can have a central hub 46 for mounting to flywheel shaft 14. In some embodiments, the drive plate 11 can have an outer diameter of about 72 inches with a radial starting point outer contact diameter of about 66 inches for engaging a drive wheel 2 having a 33 inch diameter. This can form a starting drive ratio of the drive wheel with the drive plate of 1.98:1 at 0 RPM (about 2:1), and a final or maximum ratio near the center of the drive plate of about 0.36:1 at 10,000 RPM, with the ratio being variable inbetween. The same or a similar drive plate can be used as the drive plate 11a for the generator drive assembly 18, and can be the same size or can be of different sizes as needed or desired.

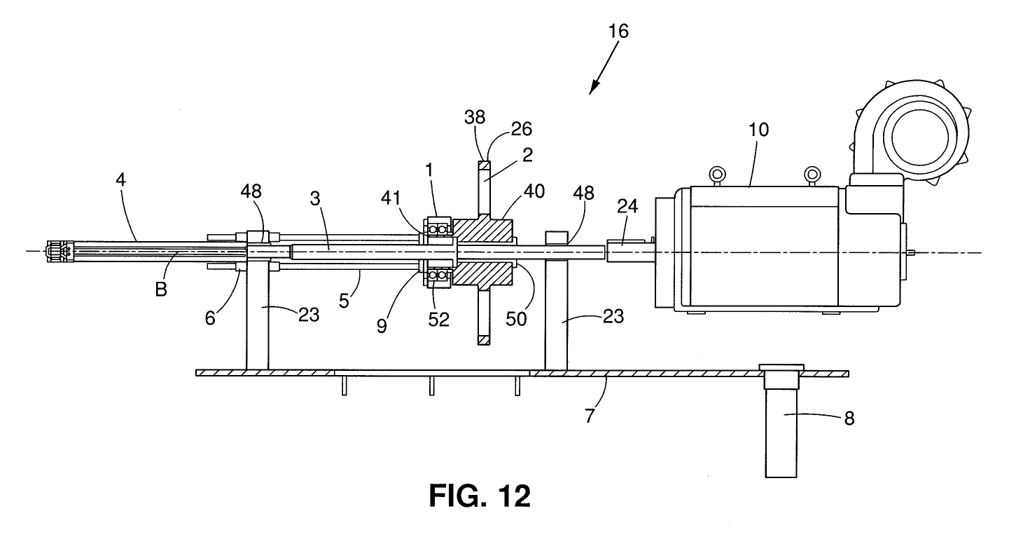

The drive ratio between the drive wheel 2 and the drive plate 11 can be varied between the upper and lower ratios by changing the position of the drive wheel 2 relative to the drive plate diameter or radius, to allow the motor 10 to drive the flywheel 12 from 0 RPM up to a desired speed, for example, between 3000 RPM to 6000 RPM in some embodiments, and up to about 10,000 RPM in other embodiments. To initially start rotation of the flywheel 12, the drive wheel 2 can be positioned at the radial starting point outer contact diameter and gradually moved inwardly toward axis A and the center of the drive plate 11 as the speed of flywheel 12 increases, until obtaining the desired speed. In some embodiments, the sizes of the drive wheel 2 and drive plate 11 can be varied as desired to obtain other ratios. FIG. 12 depicts a cross section through the drive wheel 2 and ball spline shaft 3 of the motor drive assembly 16 to show details of the drive wheel 2 on the ball spline shaft 3, the bearing housing coupler 1, and the actuator guide shafts 5, which can translate the drive wheel 2 when actuated by the linear actuator 4 to adjust the radial position of the drive wheel 2 relative to the drive plate 11. The bearing housing coupler 1 can provide an interface between the rotating drive wheel 2 and the linearly or horizontally moving non-rotating actuator guide shafts 5.

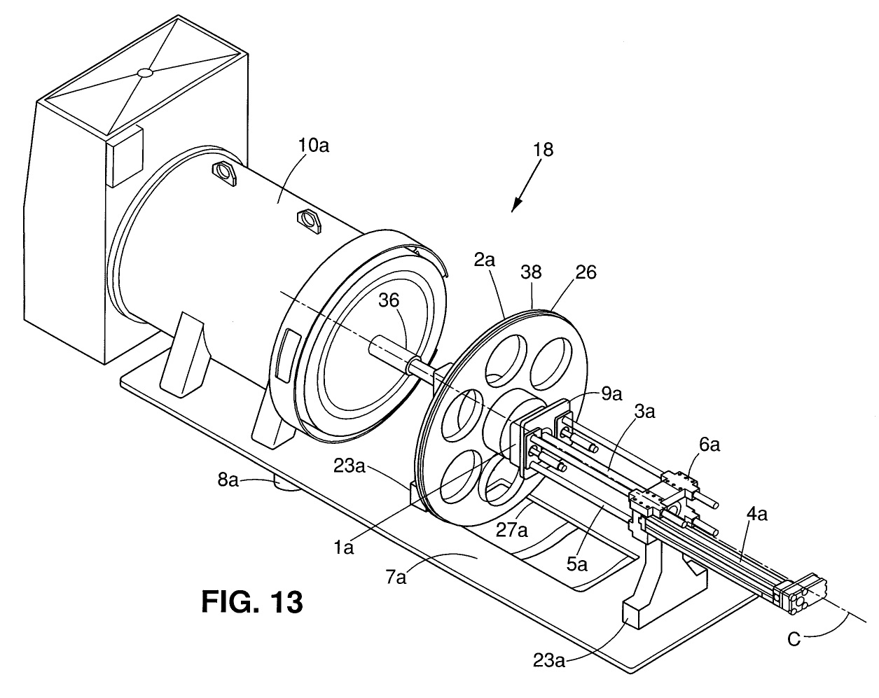

Referring to FIGS. 13-15, embodiments of the generator drive assembly 18 can have a drive plate 11a that has the same diameter and construction as the drive plate 11 for the motor drive assembly 16. In one embodiment, the drive wheel 2a of the generator drive assembly 18 can have an outer base diameter of about 41 inches with about a ½ inch outer layer of material 38 for wear and contact purposes on the outer circumference, which can result in a total outer diameter of about 42 inches. The drive wheel 2a can be formed of materials as previously described for the motor drive wheel 2. For a drive plate 11a with an outer diameter of about 72 inches and a radial starting point outer contact diameter of about 66 inches with a drive wheel 2a having a 42 inch diameter, a starting ratio with the drive wheel 2a and the drive plate 11a can be 1.584:1 at 0 RPM (about 1.5:1), and a final or maximum ratio of about 0.18:1 at 10,000 RMP, with the ratio being variable inbetween. The ratio between the drive wheel 2a and drive plate 11a in the generator drive assembly 18 can be varied between the upper and lower ratios by changing the position of the drive wheel 2a relative to the drive plate 11a diameter or radius, axis A, and drive surface 28, to drive the generator 10a at a desired or constant speed despite changes in rotational speed of the flywheel 12. To initially start rotation of the generator 10a, the drive wheel 2a can be positioned at the radial starting point outer contact diameter and gradually moved inwardly toward axis A and the center of drive plate 11a until obtaining the desired speed of generator 10a. The speed at which the generator 10a is driven can depend on the type of generator, for example, DC, AC, 60 Hz, or 50 Hz. In some embodiments, the sizes of the drive wheel 2a and drive plate 11a can be varied to obtain other ratios.

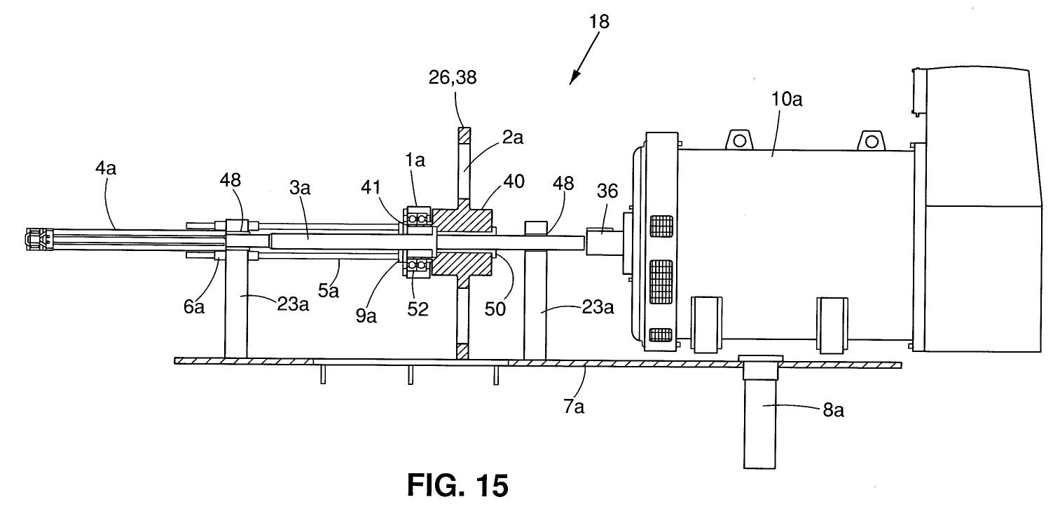

FIG. 15 depicts a cross section through the drive wheel 2a and ball spline shaft 3a of the generator drive assembly 18 to show details of the drive wheel 2a on the ball spline shaft 3a, the bearing housing coupler 1a, and the actuator guide shafts 5a which translate the drive wheel 2a when actuated by the linear actuator 4a to adjust radial position of the drive wheel 2a relative to the drive plate 11a, in a manner similar to the motor drive assembly 16.

In some embodiments, referring to FIGS. 1 and 7-9, the components of the flywheel system 25 can be mounted on a frame 34. The drive plates 11 and 11a can be positioned at opposite axial ends of the flywheel shaft 14, and can be located outside the enclosure 20 surrounding the flywheel 12. The bearings 30 can also be located outside the enclosure 20. As a result, particles generated by bearings 30, or wear between the drive wheels 2 and 2a and the drive plates 11 and 11a do not contaminate the environment within the enclosure 20 surrounding the flywheel 12. In addition, any wear is experienced on the drive plates 11 and 11a and not on the flywheel 12 itself in view that replacement of the drive plates 11 and 11a is usually less costly than repairing or replacing the flywheel 12.

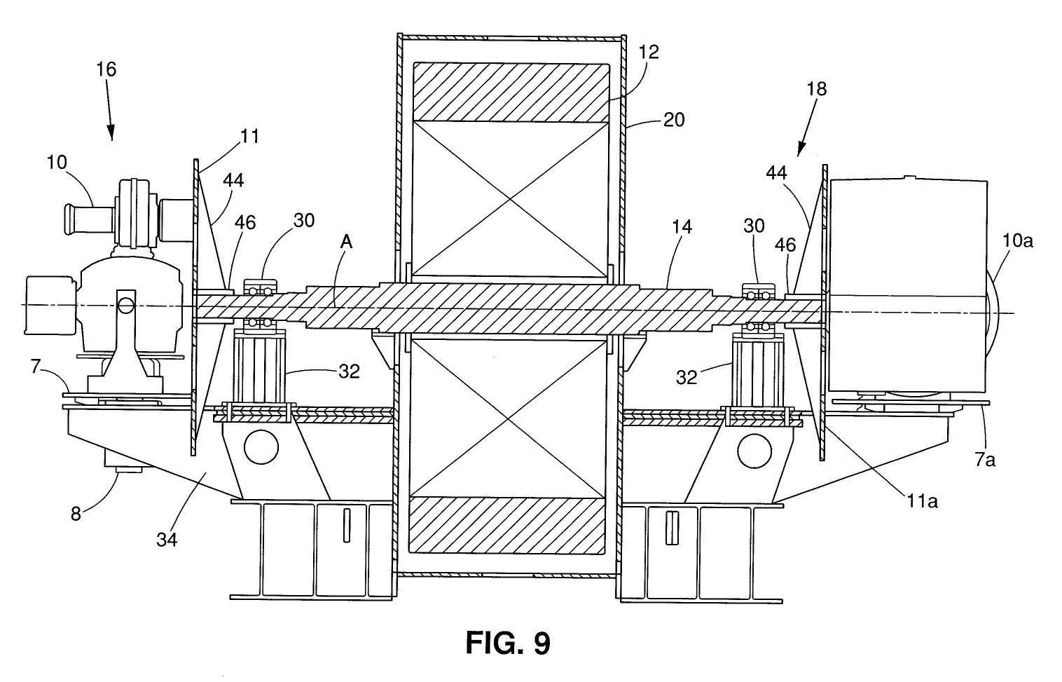

By positioning the drive plates 11 and 11a away from the flywheel 12 with a large or substantial air gap (for example, FIG. 9 shows in one embodiment drive plates 11 and 11a about one flywheel width away from flywheel 12), the flywheel 12 can be substantially thermally isolated from the drive plates 11 and 11a. In embodiments where the flywheel 12 has a composite construction with resins and adhesives, elevated temperatures can compromise the strength of the resins and adhesives which can be detrimental to the flywheel 12. Frictional heat generated by the rolling engagement of the drive plates 11 and 11a with drive wheels 2 and 2a can cause heating of the drive plates 11 and 11a. Positioning the drive plates 11 and 11a away from the flywheel 12 and substantially thermally isolating the drive plates 11 and 11a from the flywheel 12 can help reduce heating of the flywheel 12. Positioning the bearings 30 next to the drive plates 11 and 11a, can also substantially thermally isolate heat generated in bearings 30 from the flywheel 12. In addition, positioning the flywheel 12 within enclosure 20 can also provide further thermal isolation. Although flywheel shaft 14 can conduct some heat from the drive plates 11 and 11a, and bearings 30 to the flywheel 12, positioning the drive plates 11 and 11a and bearings 30 on the axial ends of the flywheel shaft 14 a substantial distance away from the flywheel 12 can help limit the amount of heat that is conducted, since the heat must travel a substantial length along flywheel shaft 14 and can be subject to cooling along the way such as, on portions of the shaft 14 exposed to the outside environment.

The drive surface 28 of the drive plates 11 and 11a in some embodiments does not have to be flat, but can be curved, angled or conical. In such situations, the drive assemblies 16 and 18 and/or the drive wheels 2 and 2a can accommodate or account for such shapes. The bearings 30 supporting the flywheel shaft 14 can be positioned outside the enclosure 20, and can be on pedestals or supports 32. If desired, the enclosure 20 can have seals 19 for sealing around the flywheel shaft 14 in order to maintain the desired environment within the enclosure 20. When the flywheel 12 is rotated about a horizontally positioned flywheel shaft 14, the forces of the drive wheels 2 and 2a on the drive plates 11 and 11a can exert lateral thrust forces on the flywheel shaft 14 in the direction of the longitudinal axis of the shaft 14 on axis A towards the flywheel 12, and do not add to the total weight of the flywheel 12 supported by the bearings 30. In situations when the two drive wheels 2 and 2a are simultaneously in contact with the two drive plates 11 and 11a, the force of the drive wheels 2 and 2a against the drive plates 11 and 11a can be in opposite axial directions and can generally cancel each other out. The size or diameter of the drive plates 11 and 11a can be smaller than the diameter of the flywheel 12.

As is evident, the type and size of motor 10 and generator 10a can be varied. In some embodiments, the motor 10 can be omitted and the flywheel 12 can be brought up to speed by mechanical rotatable power source, which can be for example, powered by water or wind. Also, the generator 10a can be a motor/generator. The linear actuators 4 and 4a can be those commercially available, and can be driven by a servo or stepper motor, but in other embodiments, can be driven by pneumatics, hydraulics, electromagnetic forces or a linear motor, or can be other suitable devices or mechanisms. The frames 7 and 7a can in some embodiments, translate linearly into and out of engagement position instead of pivoting. In some embodiments, the ball spline shafts 3 and 3a can be omitted, and the motor 10 and the generator 10a can be moved together with their respective drive wheels 2 and 2a as an assembly, for changing radial positions of the drive wheels 2 and 2a relative to the drive plates 11 and 11a. The flywheel 12, drive plates 11 and 11a and drive wheels 2 and 2a can be positioned in other orientations and along other axes, and moved or rotated in different directions or axes. In addition, the motor drive and generator drive assemblies 16 and 18 can be positioned on the same side relative to the flywheel 12, and in some embodiments, can share a single drive plate, for example, on opposite sides of the drive plate.

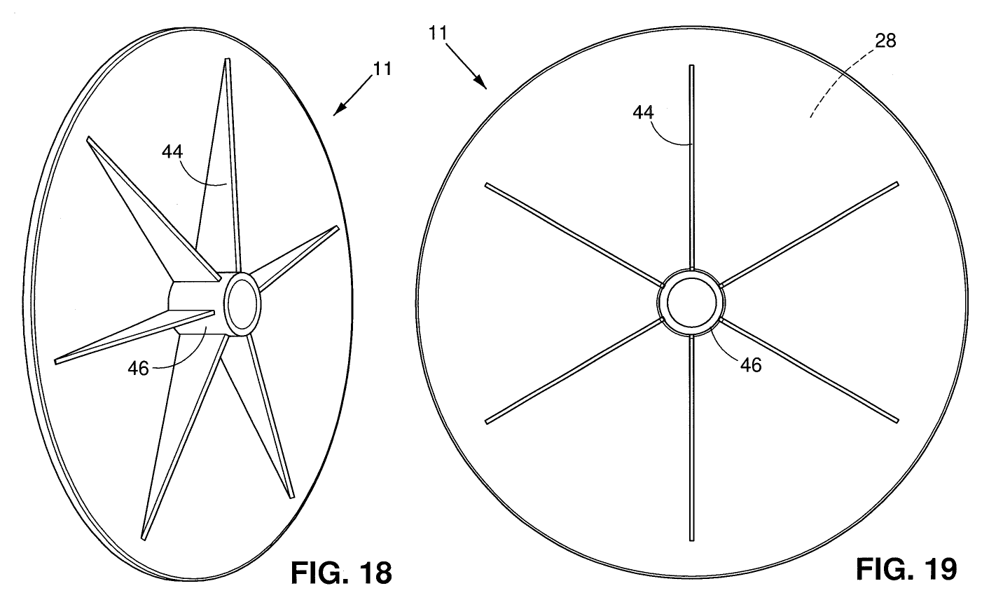

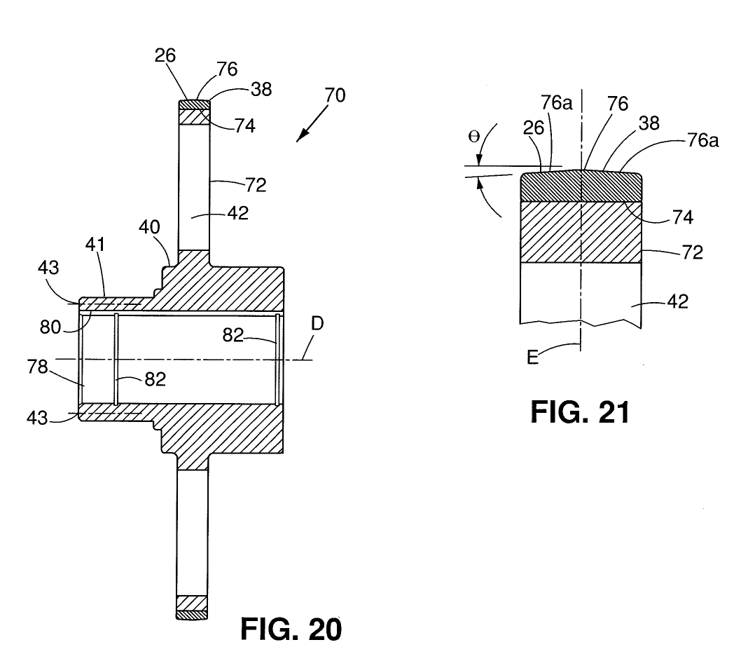

Referring to FIGS. 20 and 21, drive wheel 70 is another embodiment of a drive wheel which can be used for drive wheels 2 and 2a. The outer diameters can be similar to those previously described. The central hub 40 can have a hole or bore 78 extending along axis D, with a keyway 80 and internal retaining ring grooves 82 for securement to a spline nut 50. The wheel portion 72 extending radially outward from the central hub 40 can have a base diameter 74 over which the outer layer of material 38 can be located, positioned, applied, laminated or bonded. The outer layer of material 38 can have an annular crown 76 centered on the center or center line E of wheel portion 72, and have sloping sides 76a that slope at an angle θ from horizontal or axis D. FIG. 21 shows sides 76a of the annular crown 76 that slope at an angle θ of 3°, however, larger angles can be used, such as up to 15° in some embodiments, or greater. The outer layer of material 38 can be in one embodiment, laminated urethane, which can be 90 shore A durometer urethane. In other embodiments, other suitable materials can be used, such as these previously described for drive wheel 2. When some materials such as metals are used for material 38, the wheel portion 72 can be formed with material 38 being integral thereon, if desired.

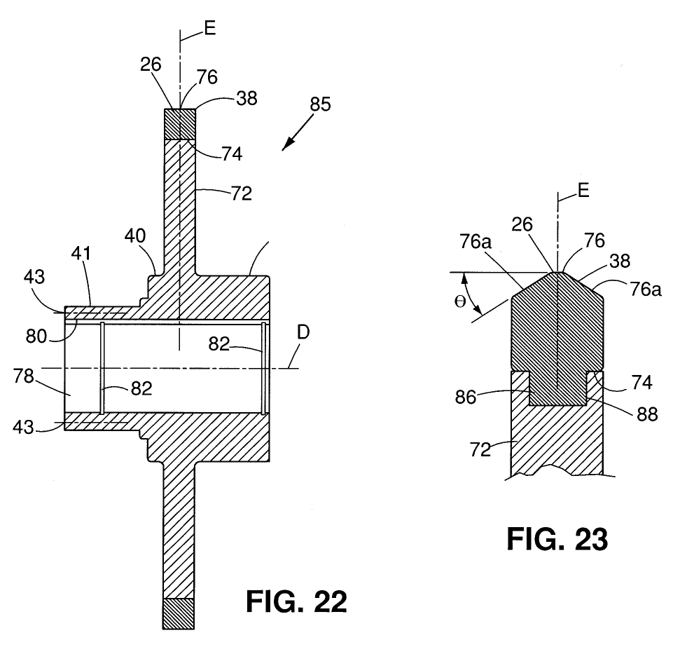

Referring to FIG. 22, drive wheel 85 is another embodiment of a drive wheel which can be used for drive wheels 2 and 2a. Drive wheel 85 can differ from drive wheel 70 in that holes 42 in the wheel portion 72 can be omitted. The outer layer of material 38, when made of urethane, can be formed of a urethane that can withstand about 1800 lb/in².

Referring to FIG. 23, in some drive wheel embodiments, the base diameter 74 of wheel portion 72 can have an annular groove 88 which engages a narrowed annular rim or edge portion 86 of the outer layer of material 38. The annular crown 76 can be radiused, for example, with about a ⅛ inch radius. The sides of 76a of the crown 76 can slope at an angle θ which can be as large as about 30°.

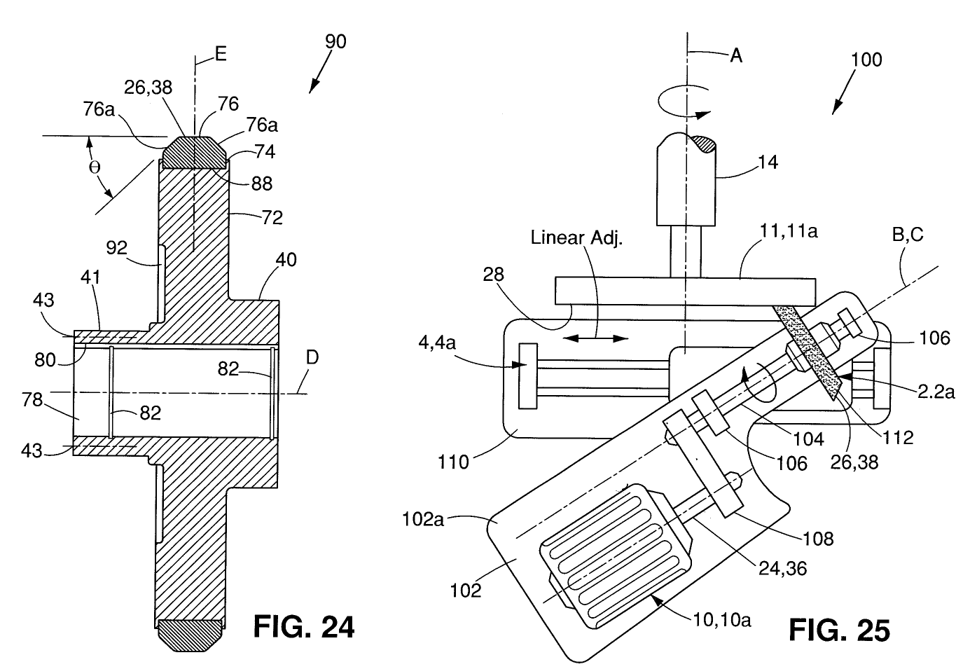

Referring to FIG. 24, drive wheel 90 is another embodiment of a drive wheel which can be used for drive wheels 2 and 2a. Drive wheel 90 can differ from drive wheel 85 in that wheel portion 72 and the outer layer of material 38 can be thicker or wider, and the bottom of the outer layer of material 38 can engage an annular groove 88 in the base diameter 74. The crown 76 can have a central flat portion, and sloping sides 76a which can slope at an angle θ of about 45°. The side of the wheel portion 72 facing neck 41 can have an annular relief portion 92 formed thereon. The outer layer of material 38 when made of urethane, can be formed of a urethane that can withstand about 2500 lb/in².

In some embodiments, various features of the drive wheels described can be combined or omitted. In addition, the dimensions can vary depending upon the situation at hand. The outer layer of material 38 in some embodiments can be radiused, such as in the manner of a bicycle tire. In some cases, the outer layer of material 38 can be integrally formed with or in the drive wheel (drive wheel made of same material). In addition, the crown 76 can be made with a very narrow contact edge for point contact.

Referring to FIG. 25, drive assembly 100 is another embodiment of a drive assembly that can be used for motor drive assembly 16 and/or generator drive assembly 18. The drive wheel 2 or 2a can have a beveled or angled drive, engagement or contact surface 112 on the outer rim, periphery or circumference 26 forming a generally frustoconical shaped wheel for engaging the drive surface 28 of the drive plate 11 or 11a in rolling contact. The angled contact surface 112 can be for example, about 30° relative to rotational axis B or C, but can be at larger or smaller angles, for example, 45 or 15 degrees. The drive wheel 2 or 2a can be part of a drive wheel assembly 102 and can be rotatably coupled to a rotatable shaft 104 about axis B or C, that can be rotatably supported between two mounts 106, secured on a mounting plate or base 102a. Drive wheel 2 or 2a can be rotationally and linearly fixed relative to shaft 104. The drive shaft 24 or 36 of the motor 10 or generator 10a, can be rotatably connected to shaft 104 by a transmission 108, for example, a pulley or gear transmission. In some embodiments, the transmission 108 can have other configurations and/or orientations, or can be omitted, and the shaft 24 or 36 of the motor 10 or generator 10a can be coupled to the shaft 104 along axis B or C. The drive wheel assembly 102 and therefore the drive wheel 2 or 2a, can be secured to a linear actuator 4 or 4a, and translated laterally or transverse relative to axis A and along or parallel to the drive surface 28 of the drive plate 11 or 11a, by the linear actuator 4 or 4a in the directions of the arrows (which can be perpendicular to axis A). The linear actuator 4 or 4a can be mounted to a mount or base 110. Movement of the drive wheel 2 or 2a relative to the drive plate 11 or 11a can change drive ratios and rotational speeds. The beveled or angled contact surface 112 of the drive wheel 2 or 2a, can contact the drive surface 28 of the drive plate 11 or 11a in rolling engagement, with the axis of rotation B or C, of the drive wheel 2 or 2a, being at an acute angle or transverse relative to the plane of the drive surface 28, and forming a transverse transmission with the drive plate 11 or 11a. The axis B or C, can also be at a non-perpendicular or acute angle transverse or relative to axis A. In the embodiment shown, the inwardly angled sides of the contact surface 112 of the drive wheels 2 or 2a can point in the direction of the outer perimeter of the drive plate 11 or 11a. The frustoconical shape of the drive wheel 2 or 2a with the beveled contact surface 112 engaging the flat or planar drive surface 28 of the drive plate 11 or 11a in rolling contact, can provide desirable wear characteristics. The drive wheel 2 or 2a can be formed of materials and can have an outer layer of material 38 as previously described. In some embodiments, the drive wheel 2 or 2a can be positioned axially beyond the distal mount 106 in a cantilevered manner, and the contact surface 112 of the drive wheel 2 or 2a can be angled in the opposite direction, and/or engage the drive surface 28 on the opposite side of axis A.

While this invention has been particularly shown and described with references to example embodiments thereof, it will be understood by those skilled in the art that various changes in form and details may be made therein without departing from the scope of the invention encompassed by the appended claims.

For example, various features described shown can be omitted or combined. In addition, it is understood that sizes and dimensions of the components can vary.

What is claimed is:

1. A variable speed drive for a flywheel system comprising:
a first rotatable drive plate for coupling to a rotatable flywheel positioned about an axis of rotation and having a drive surface lying generally across the axis of rotation;
a first rotatable drive wheel having an outer circumference for engaging and being driven by the drive surface of the first drive plate;
a generator rotatably coupled to the first drive wheel; and
a first actuator for controlling position of the first drive wheel relative to radial drive surface location on the first drive plate for controlling drive ratio and rotational speed of the generator.

2. The drive of claim 1 further comprising a control system for controlling the position of the first drive wheel to provide a constant rotational speed of the generator with changing rotational speed of the first drive plate.

3. The drive of claim 1 in which the first drive wheel is rotatably locked to a first drive wheel shaft while also being linearly slidable thereon, the first actuator controlling linear position of the first drive wheel on the first drive wheel shaft.

4. The drive of claim 1 further comprising:
a rotatable power source;
a second rotatable drive wheel coupled to the rotatable power source;
a second rotatable drive plate for coupling to the rotatable flywheel positioned about the axis of rotation and having a drive surface lying generally across the axis of rotation, the second drive wheel having an outer circumference for engaging the drive surface of the second drive plate for rotatably driving the second drive plate; and
a second actuator for controlling radial position of the second drive wheel relative to radial drive surface location on the second drive plate for controlling drive ratio and rotational speed at which the second drive plate is driven.

5. The drive of claim 4 further comprising a control system for controlling the position of the second drive wheel to drive the second drive plate at a desired rotational speed.

6. The drive of claim 4 in which the second drive wheel is rotatably locked to a second drive wheel shaft while also being linearly slidable thereon, the second actuator controlling linear position of the second drive wheel on the second drive wheel shaft.

7. A flywheel system comprising:
a rotatable flywheel mounted on a horizontal flywheel shaft and rotatable about an axis of rotation;
a generator drive assembly driven by the flywheel, the generator drive assembly comprising;
a first rotatable drive plate mounted to the flywheel shaft for rotation about the axis of rotation and having a drive surface lying generally across the axis of rotation;
a first rotatable drive wheel having an outer circumference for engaging and being driven by the drive surface of the first drive plate;
a generator rotatably coupled to the first drive wheel;
a first actuator for controlling position of the first drive wheel relative to radial drive surface location on the first drive plate for controlling drive ratio and rotational speed of the generator.

8. The flywheel system of claim 7 further comprising a control system for controlling the position of the first drive wheel to provide a constant rotational speed of the generator with changing rotational speed of the first drive plate.

9. The flywheel system of claim 7 in which the first drive wheel is rotatably locked to a first drive wheel shaft while also being linearly slidable thereon, the first actuator controlling linear position of the first drive wheel on the first drive wheel shaft.

10. The flywheel system of claim 7 further comprising a drive assembly for driving the flywheel to a desired speed, the drive assembly comprising:
a rotatable power source;
a second rotatable drive wheel coupled to the rotatable power source;
a second rotatable drive plate mounted to the flywheel shaft for rotation about the axis of rotation and having a drive surface lying generally across the axis of rotation, the second drive wheel having an outer circumference for engaging the drive surface of the second drive plate for rotatably driving the second drive plate and the flywheel; and
a second actuator for controlling radial position of the second drive wheel relative to radial drive surface location on the second drive plate for controlling drive ratio and rotational speed at which the second drive plate and flywheel are driven.

11. The flywheel system of claim 10 further comprising a control system for controlling the position of the second drive wheel to drive the second drive plate and the flywheel at a desired rotational speed.

12. The flywheel system of claim 10 in which the second drive wheel is rotatably locked to a second drive wheel shaft while also being linearly slidable thereon, the second actuator controlling linear position of the second drive wheel on the second drive wheel shaft.

13. The flywheel system of claim 10 in which the first and second drive plates are located on opposite sides of the flywheel and are spaced apart from the flywheel.

14. The flywheel system of claim 13 in which the drive surfaces of the first and second drive plates face outwardly relative to the flywheel such that the first and second drive wheels exert force on the first and second drive plates in generally opposite axial directions.

15. The flywheel system of claim 14 further comprising an enclosure surrounding the flywheel, the first and second drive plates being located outside the enclosure.

16. A method of driving a generator with a variable speed drive for a flywheel system comprising:
coupling a first rotatable drive plate to a rotatable flywheel positioned about an axis of rotation and having a drive surface lying generally across the axis of rotation;
engaging an outer circumference of a first rotatable drive wheel with the drive surface of the first drive plate for driving the first drive wheel;
rotatably coupling a generator to the first drive wheel; and
with a first actuator, controlling position of the first drive wheel relative to radial drive surface location on the first drive plate for controlling drive ratio and rotational speed of the generator.

17. The method of claim 16 further comprising controlling the position of the first drive wheel with a control system to provide a constant rotational speed of the generator with changing rotational speed of the first drive plate.

18. The method of claim 16 further comprising rotatably locking the first drive wheel to a first drive wheel shaft while also being linearly slidable thereon, the first actuator controlling linear position of the first drive wheel on the first drive wheel shaft.

19. The method of claim 16 further comprising:
providing a rotatable power source;
coupling a second rotatable drive wheel to the rotatable power source;
coupling a second rotatable drive plate to the rotatable flywheel positioned about the axis of rotation and having a drive surface lying generally across the axis of rotation, the second drive wheel having an outer circumference for engaging the drive surface of the second drive plate for rotatably driving the second drive plate; and
with a second actuator, controlling radial position of the second drive wheel relative to radial drive surface location on the second drive plate for controlling drive ratio and rotational speed at which the second drive plate and the flywheel are driven.

20. The method of claim 19 further comprising controlling the position of the second drive wheel with a control system to drive the second drive plate at a desired rotational speed.

21. The method of claim 19 further comprising rotatably locking the second drive wheel to a second drive wheel shaft while also being linearly slidable thereon, the second actuator controlling linear position of the second drive wheel on the second drive wheel shaft.

22. A method of driving a generator with a flywheel system comprising:
mounting a rotatable flywheel on a horizontal flywheel shaft and rotating about an axis of rotation;
driving a generator drive assembly with the flywheel by,
mounting a first rotatable drive plate to the flywheel shaft for rotation about the axis of rotation and having a drive surface lying generally across the axis of rotation;
engaging an outer circumference of a first rotatable drive wheel with the drive surface of the first drive plate for driving the first drive wheel;
rotatably coupling the generator to the first drive wheel; and
with a first actuator, controlling position of the first drive wheel relative to radial drive surface location on the first drive plate for controlling drive ratio and rotational speed of the generator.

23. The method of claim 22 further comprising controlling the position of the first drive wheel with a control system to provide a constant rotational speed of the generator with changing rotational speed of the first drive plate.

24. The method of claim 22 further comprising rotatably locking the first drive wheel to a first drive wheel shaft while also being linearly slidable thereon, the first actuator controlling linear position of the first drive wheel on the first drive wheel shaft.

25. The method of claim 22 further comprising driving the flywheel to a desired speed with a drive assembly comprising:
providing a rotatable power source;
coupling a second rotatable drive wheel to the rotatable power source;
mounting a second rotatable drive plate to the flywheel shaft for rotation about the axis of rotation and having a drive surface lying generally across the axis of rotation, the second drive wheel having an outer circumference for engaging the drive surface of the second drive plate for rotatably driving the second drive plate and the flywheel; and
with a second actuator, controlling radial position of the second drive wheel relative to radial drive surface location on the second drive plate for controlling drive ratio and rotational speed at which the second drive plate and flywheel are driven.

26. The method of claim 25 further comprising controlling the position of the second drive wheel with a control system to drive the second drive plate and the flywheel at a desired rotational speed.

27. The method of claim 25 further comprising rotatably locking the second drive wheel to a second drive wheel shaft while also being linearly slidable thereon, the second actuator controlling linear position of the second drive wheel on the second drive wheel shaft.

28. The method of claim 25 further comprising locating the first and second drive plates on opposite sides of the flywheel and spaced apart from the flywheel.

29. The method of claim 28 further comprising facing the drive surfaces of the first and second drive plates outwardly relative to the flywheel such that the first and second drive wheels exert force on the first and second drive plates in generally opposite axial directions.

30. The method of claim 29 further comprising surrounding the flywheel within an enclosure, the first and second drive plates being located outside the enclosure.
